(19) United States
(12) Patent Application Publication
(10) Pub. No.: US 2004/0158839 A1
(43) Pub. Date: Aug. 12, 2004

(54) Method and system for processing event of softswitch open type system

(76) Inventor: Seung-Hyun Lee, Seoul (KR)

Correspondence Address: Robert E. Bushnell, Suite 300, 1522 K Street, N.W., Washington, DC, 20005-1202, US

(21) Appl. No.: 10/747,283

(22) Filed: Dec. 30, 2003

(30) Foreign Application Priority Data
Jan. 8, 2003 (KR) 2003-1139

(51) Int. Cl. G06F 9/46

(52) U.S. Cl. 719/318

(57) ABSTRACT

In a method and system for processing an event of a softswitch open type system, an OAMP operator can easily implement an event processing interface between different devices or different processes. If one alarm event is generated, in order for the application to transmit the event to a Relim, each element of the system event includes event handlers, an event related library, a DataRedirection element for performing a posting function between elements for an event object, and a CM which receives an event object transmitted from the application using a remote service. The Relim posts the event using the remote service and, if a generated event is an arbitrary event, not an alarm/fault event, the event is reposted to the relevant event processing element. With such a construction, realization of the software is facilitated from the standpoint of the application user, and an event can be transmitted to a relevant element by a single call with the use of an event processing function included in the element itself so that a separate interface with the relevant element is not required.

### CLAIM OF PRIORITY

This application makes reference to, incorporates the same herein, and claims all benefits accruing under 35 U.S.C. §119 from an application for METHOD FOR PROCESSING EVENT OF SOFTSWITCH OPEN TYPE SYSTEM earlier filed in the Korean Intellectual Property Office on 8 Jan. 2003 and thereby duly assigned Serial No. 2003-1139.

### BACKGROUND OF THE INVENTION

1. Technical Field

The present invention relates to a method and system for processing an event of a softswitch open type system, and more particularly, to a method and system for an operations, administration, maintenance and performance (OAMP) operator to easily implement an event processing interface between different devices or different processes.

2. Related Art

In the future, integrated service for making cooperative or compatible a variety of communication services, including a subscriber network, a public switched telephone network (PSTN) and an enterprise communication network, will be provided. Cooperation between different networks is performed in a gateway, and a media gateway for processing a variety of such services is required.

Such media gateway should provide a variety of signaling protocols and signaling controls, and a mechanism for integrally providing such functions is called a softswitch.

The softswitch provides additional service to media gates and internet protocol (IP) terminals, and provides proper service for each call by performing a call process according to a subscriber and a service provider. The softswitch is developed on the basis of an open type structure, and a call processing section and a media transmission section are separately provided so that an application program interface (API) and a protocol between them are defined.

In order for such a softswitch open type system to process a variety of events, separate event processing is required.

A method for processing an event of the related art will be described hereinafter, taking as an example an alarm/fault event that falls on an interruption event among many events.

In the related art, the processing of an interruption (alarm/fault) event has been performed by use of a group service provided from a distributed processing environment.

In order to use a group service function between modules, an application user should employ a client interface block and a server interface in order to make communication between modules possible. These two classes could realize their functions by inheriting a variety of classes provided from the group service function, and a method for using a variety of classes provided from the group service function should be well learned.

An application user should design an object class that would be transmitted between a client and a server. Also, since many related classes of group service should be inherited and changed into a DTN message form, which is a group service transmission unit class, the parts that should be realized by module managers increase. Therefore, the OAMP operator or call processor (CP) operator, who primarily does not use group service, has much difficulty in using group service.

The following patents are considered to be generally pertinent to the present invention, but are burdened by the disadvantages set forth above: U.S. Pat. No. 6,628,629 to Jorgensen, entitled RESERVATION BASED PRIORITIZATION METHOD FOR WIRELESS TRANSMISSION OF LATENCY AND JITTER SENSITIVE IP-FLOWS IN A WIRELESS POINT TO MULTI-POINT TRANSMISSION SYSTEM, issued on Sep. 30, 2003; U.S. Pat. No. 6,594,246 to Jorgensen, entitled IP-FLOW IDENTIFICATION IN A WIRELESS POINT TO MULTI-POINT TRANSMISSION SYSTEM, issued on Jul. 15, 2003; and U.S. Pat. No. 6,363,424 to Douglas et al., entitled REUSE OF SERVICES BETWEEN DIFFERENT DOMAINS USING STATE MACHINE MAPPING TECHNIQUES, issued on Mar. 26, 2003.

### SUMMARY OF THE INVENTION

It is, therefore, an object of the present invention to provide a method for processing an event of a softswitch open type system, capable of calling and processing the relevant handling class by reposting the relevant capsule-related event object only to each relevant capsule at the events posted to an event master module, and by posting a necessary event to a class of the relevant capsule only, in connection with an event processing function, in the management of an event by an operator.

To achieve the above object, there is provided a method for processing an event of a softswitch open type system, the method including the steps of: calling an event handler using an event processing function, and transmitting (posting) the generated events to a configuration management (CM) element, designated as an event processing master, when an event is generated at each application; posting the generated event to a relevant module according to the kind of event; and processing the event transmitted to the relevant module by calling a relevant event handling class. In addition the first step (the calling step) comprises the sub-steps of: detecting an event at an application; constructing, at an event handler, an event called an issueEvent; calling an eventTransport in order to search a Thread; requesting a DataTransport for event posting; calling, at a DataConsumer, a remote service generating function in order to post an event to the configuration management (CM) element; and posting an event to the DataConsumer of the CM element using a remote service.

The second step (the posting step) comprises the sub-steps of: posting an event to a DataQueue; transmitting an event to an eventThread; performing, at a Thread, an infinite loop in order to receive another event, in which process is overridden to a DataTransport class; requesting posting of an event object; determining to which function an event should be posted; determining validity as to whether an event object is used at a relevant capsule through a filter when a class to which an event would be posted is determined; calling a remote service generating function in order to post an event to a relevant capsule; and posting an event to a DataConsumer of a relevant capsule using a remote service.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a drawing schematically showing an event processing block for posting, at a softswitch, an event to each relevant capsule according to a preferred embodiment of the present invention;

FIG. 2 is a drawing defining a class construction and an inheritance relation for processing an interruption (alarm/fault) event among events;

FIG. 3 is a drawing showing a Thread generation and preparation procedure for an alarm/fault event posting;

FIG. 4 is a drawing showing a procedure for registering, to the relevant capsule with filtering, a relevant event from an interruption event capsule;

FIG. 5A is a flowchart of a procedure for posting an event from an application to a CM according to a preferred embodiment of the present invention;

FIG. 5B is a flowchart of a procedure for reposting an event from a CM to a Relim capsule according to a preferred embodiment of the present invention; and

FIG. 5C is a flowchart of a procedure for processing an event at a Relim capsule according to a preferred embodiment of the present invention.

### DETAILED DESCRIPTION OF THE PREFERRED EMBODIMENT

A preferred embodiment of the present invention will now be described with reference to the accompanying drawings, so that one of ordinary skill in the art could easily perform the present invention.

Before providing a detailed description of the present invention, terminology used in the detailed description will be defined as follows:

Capsule: execution result file (a.out) in unit of module.

Configuration management (CM): a softswitch OAMP capsule which performs functions of registering, deleting, managing a capsule for each node, and which operates as a master of event processing.

Relim: a reliability module and a capsule for performing an alarm procedure when a fault occurs in a softswitch system.

Posting: positioning an object to a data queue existing in a different capsule.

Remote service: a kind of group service for communication between different capsules, it supports event communication between capsules under the OAMP environment. In order to use remote service, a capsule between communications should be compiled by linking to a library of the same class, and a master/slave relation between two capsules must be defined. In the case of a false master, an object is transmitted to a capsule having a link to a class library set to true. Remote service is mainly used for interface between OAMP applications.

DataRedirection: a framework provided by an OAMP and providing a posting function between data queues for object transmission between different capsules. In order to use the DataRedirection function, a class of a DataConsumer should be formed.

Construction of the present invention will be described, taking as an example an alarm/fault event among many events, in the following section.

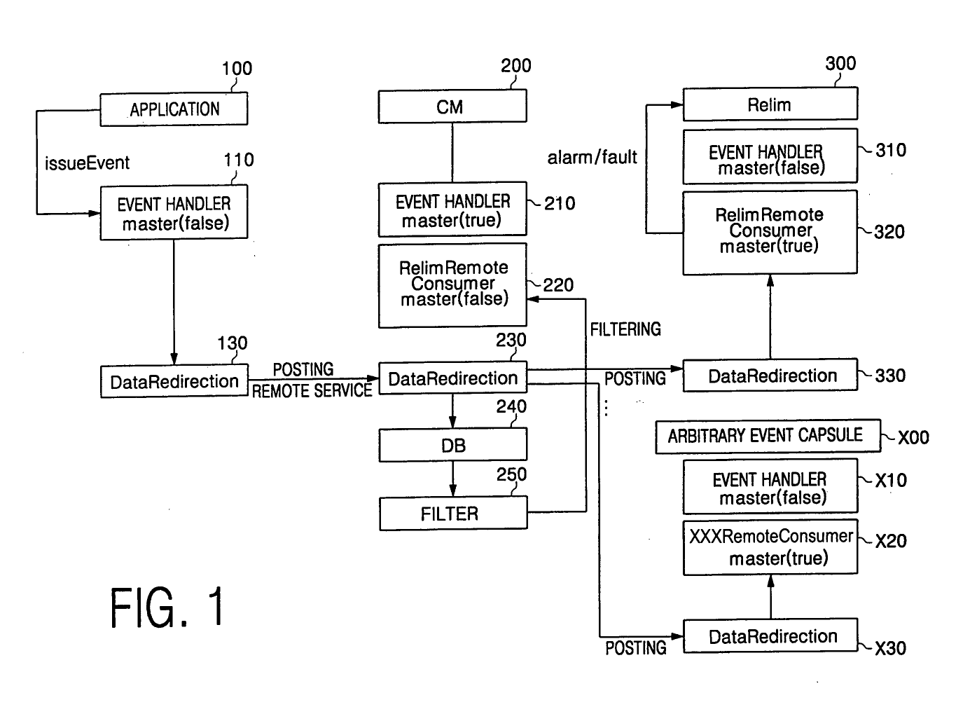

FIG. 1 is a schematic view of an event processing block for posting, at a softswitch, an event(particularly an alarm/fault event) to each relevant capsule according to a preferred embodiment of the present invention.

Referring to FIG. 1, elements necessary for posting an event to each capsule in event processing include: an application 100 for generating an event if an event is detected; a CM 200 for performing the function of a master of event process; a Relim 300 for finally receiving and processing an interruption (alarm/fault) event among a number of events; and an arbitrary event capsule X00 for finally receiving and processing an event with respect to another event.

With such a construction, if one alarm event is generated, in order for there to be transmission from the application 100 to the Relim 300, each element 100, 200, 300, X00 should include: event handlers 110, 210, 310, X10; an event related library (not shown); and DataRedirection elements 130, 230, 330, X30 related to a class library for performing a posting function between capsules for an event object.

The CM 200 sets the event handler 210 to master=true in order to receive an event object transmitted from the application 100 using a remote service. When an event object is filtered by a filter 250 and determined to be an alarm/fault event, the CM 200 sets the RelimRemoteConsumer 220 to master=false in order to repost to the Relim 300.

For posting an alarm/fault event, the Relim 300 includes: an event related class and library; a DataRedirection element 330; and a RelimRemoteConsumer element 320 for performing the functions of determining and filtering an alarm/fault event.

In order to receive an event, the Relim 300 sets the event handler 310 to master=false using a remote service, setting the RelimRemoteConsumer 320 to master=true. Such setting is just the opposite of a master flag setting for remote service of the CM 200.

If a generated event is not an alarm/fault event, the CM 200 sets the event handler 210 to master=true in order to receive an event object transmitted from the application 100 using a remote service, setting the RelimRemoteConsumer 220 to master=false in order to filter an event object by means of the filter 250 and to repost the same to the relevant event processing element (e.g., arbitrary event capsule X00).

In order to repost the relevant event, the arbitrary event capsule X00 includes: an event related class and library (not shown); a DataRedirection element X30; and a relevant RelimRemoteConsumer element X20 for performing the functions of determining and filtering the relevant event.

For receiving the event, an arbitrary event capsule X00 sets the event handler X10 to master=false using a remote service, setting the relevant event RemoteConsumer element X20 to master=true.

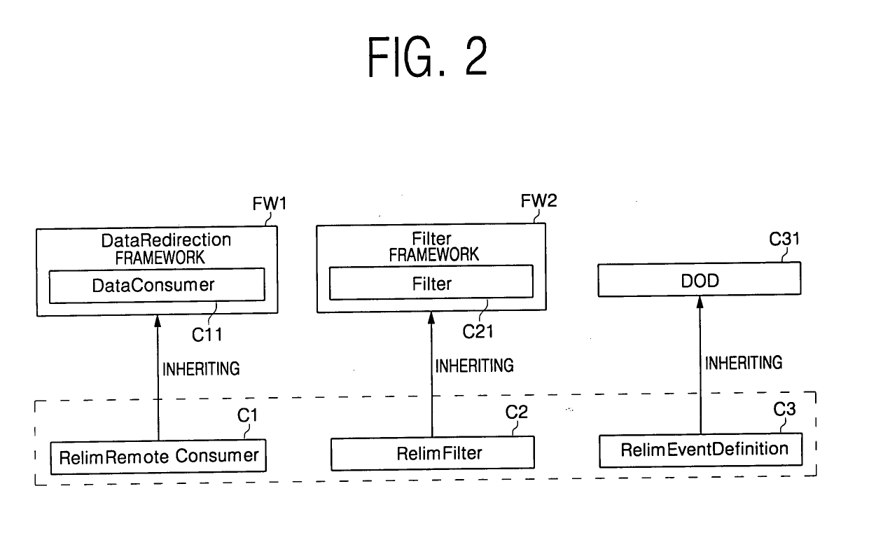

Construction of the alarm/fault event related class is described as follows with respect to FIG. 2 which is a drawing defining a class construction and inheritance relation for processing an interruption(alarm/fault) event among various events.

Referring to FIG. 2, class construction for posting an alarm/fault event to the Relim 300, includes: a RelimRemoteConsumer C1 to inherit a DataConsumer C11 of a DataRedirection framework FW1; a RelimFilter C2 to inherit a filter C21 of a filter framework FW2; and a RelimEventDefinition C3 to inherit a dynamic object definition (DOD) C31.

The functions of the various elements for processing each alarm event is as follows.

The RelimFilter C2 inherits the filter C21 of the filter framework FW2, determining for which DataConsumer an event object initially posted to the CM 200 is used. The RelimFilter C2 performs filtering so that an alarm/fault event object, among the event information posted to the CM 200, can be processed by the RelimRemoteConsumer C1.

Upon operation of the Relim 300, the RelimFilter C2 information is stored in database (DB) 240 together with the RelimRemoteConsumer C1 information as a pair of data to be used upon reception of event information.

The RelimEventDefinition C3 uses alarm/fault objects defined in a Reli-events-dods.ini file as determining data upon filtering in the RelimFilter C2.

An alarm/fault object list presently used for the softswitch is shown in Table 1.

TABLE 1

| | Detect | |
|---|---|---|
| Event Name | Application | Event Description |
| E_AMStorageLowAlert | Accoserv | For the case that billing disk |
| | | occupying ratio exceeds the |
| | | critical value |
| NedeProcessorFail | CM | Upon interruption of nodes |
| | | constituting the softswitch |
| CapsuleProcessorFail | CM | Upon interruption of capsule |
| | | constituting the softswitch |
| NECommunicationFailure | NCM | Upon interruption of other |
| | | system(AGW/TGW/SS) |
| | | cooperating with the |
| | | softswitch |
| E_ChaFileDumpFail | AccoServ | Upon failure of bill file dump |
| E_CPU_Overload | PaManager | Upon exceeding of use ratio |
| | | of CPU overload beyond a |
| | | critical value |
| E_BSLinkFail | AccoServ | Upon interruption of link to a |
| | | billing center |
| E_CGLinkFail | AccoServ | Upon interruption of link to a |
| | | billing gateway |

The procedure of posting between each element when an alarm/fault event is actually generated will be described hereinafter.

Initially, the CM 200 generates an event thread for performing the posting of all event information, as well as an alarm/fault event.

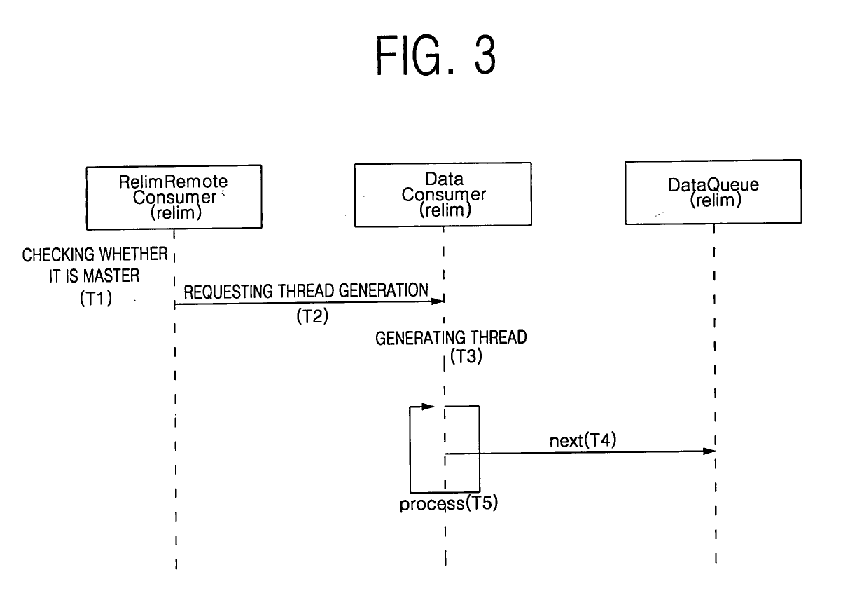

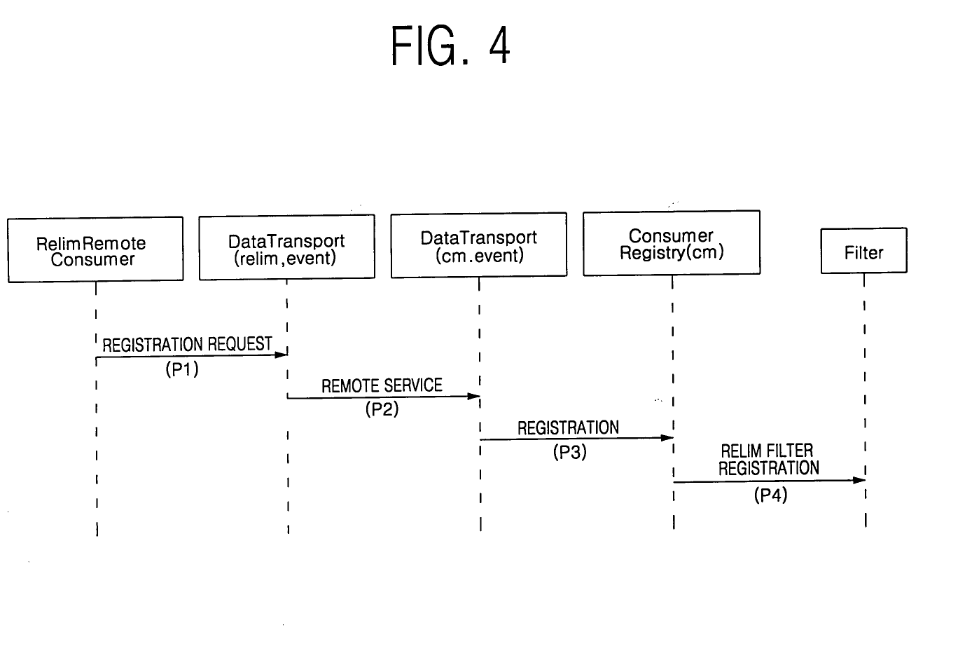

FIG. 3 is a drawing showing a Thread generation and preparation procedure for an alarm/fault event posting, and FIG. 4 is a drawing showing a procedure for filtering the relevant event from an interruption event element registering to a relevant element.

The following explanation is made by taking an alarm/fault event as an example. As shown in FIG. 3, a determination is made as to whether the Relim 300, which is a master element for the RelimRemoteConsumer 320, is set to master (T1). If master is set to true, it is requested that an independent thread be generated so that an event object of its own can be processed (T2). The DataConsumer of the DataRedirection framework, which is a parent of the RelimRemoteConsumer 220, generates the event posting DataQueue for the RelimRemoteConsumer 220 (T3), performing a member function process for processing an event when an event is posted to the DataQueue of the RelimRemoteConsumer 220 (T4, T5).

In addition, a determination is made as to whether an object is posted to the DataQueue so that overriding to the RelimRemoteConsumer 320 can be performed when an event object is posted to the DataQueue of the Relim 300.

If the thread is generated in this manner, as shown in FIG. 4, the RelimRemoteConsumer 320 makes a registration request of the RelimRemoteConsumer 320 and the RelimFilter to the DataTransport used by an event, using event handler 310 in the Relim 300 (P1).

This information (the consumer and filter used by the generated event) is sent to the DataRedirection 230 of the CM 200 by using a remote service (P2) in order to be registered in the CM 200, which is a master capsule of an event process function. Also, the event processing function of the CM 200 registers the RelimDataConsumer required by the Relim 300 (P3), registering the RelimFilter 250 for filtering of an alarm/fault event object (P4).

The RelimFilter 250 determines in which function an event object would be used among the classes inheriting the DataConsumer when an event object is posted to the event processing function of the CM 200. An alarm/fault event is used in the RelimRemoteConsumer 220 by means of the RelimFilter 250.

The whole process of posting an event from the application 100 to the CM 200, and posting from the CM 200 to the Relim 300, will be described hereinafter.

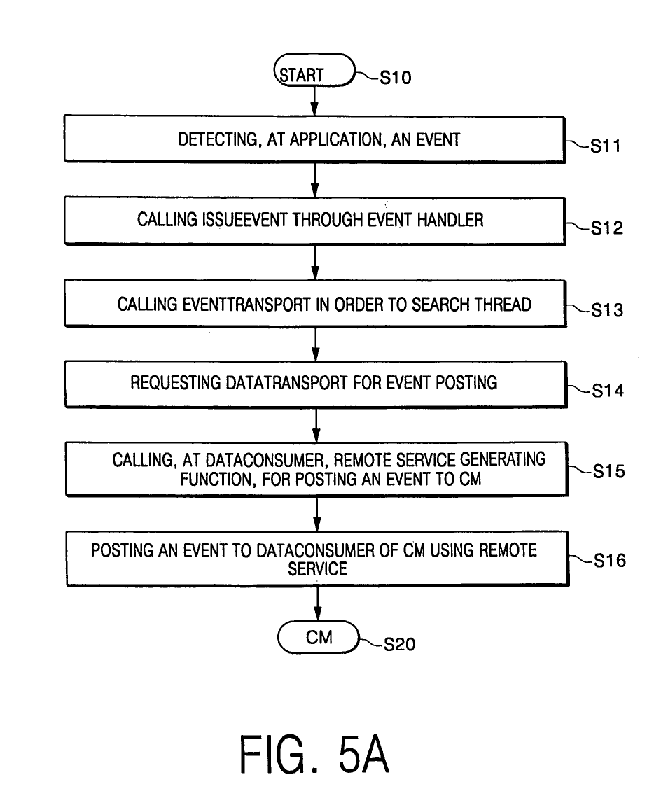

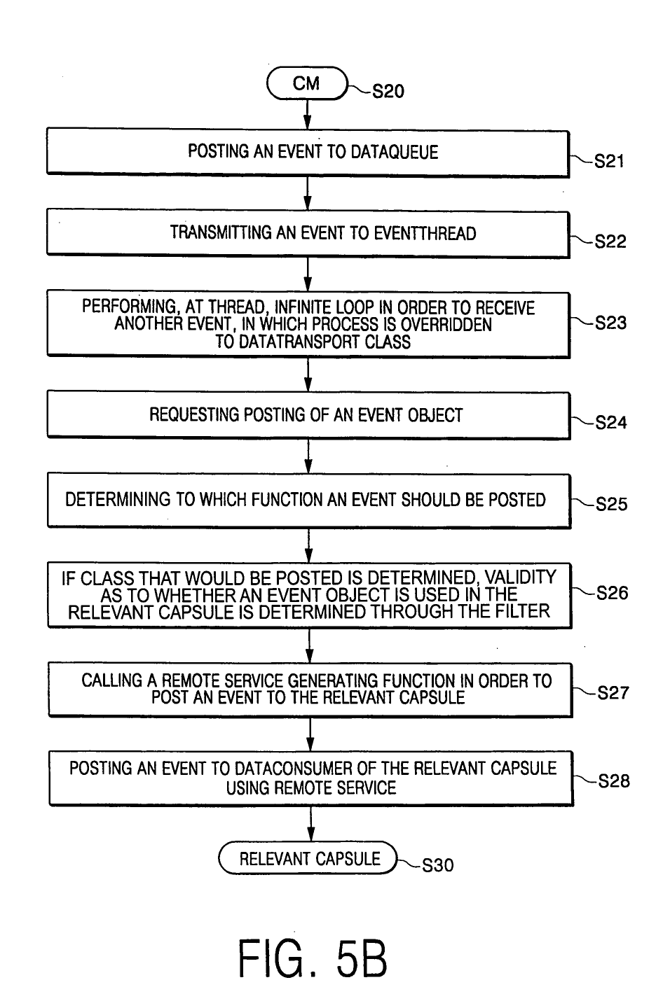

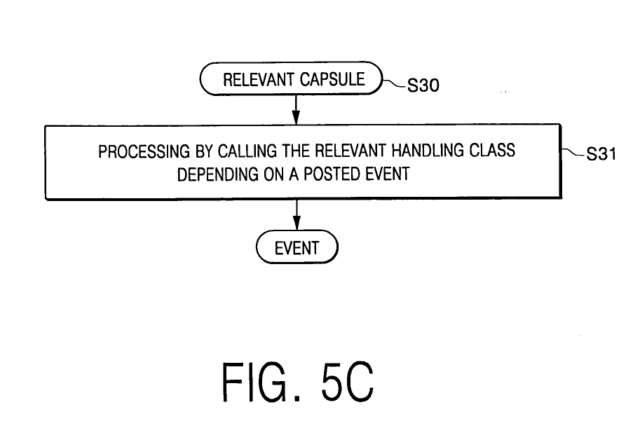

FIG. 5A is a flowchart of a procedure for posting an event from the application 100 to the CM 200 according to a preferred embodiment of the present invention, FIG. 5B is a flowchart of a procedure for reposting an event from the CM 200 to the Relim 300 according to a preferred embodiment of the present invention, and FIG. 5C is a flowchart of a procedure for processing an event at the Relim 300 according to a preferred embodiment of the present invention.

Referring to FIG. 5A, the procedure (S10) for posting an event from the application 100 to the CM 200 is described as follows. Initially, if an event is detected by the application 100 (S11), an event is constructed in an issueEvent of the event handler 110 and is called (S12).

The event handler 110 calls the eventTransport in order to search a thread existing in the application 100 (S13), requesting the DataTransport generated in the application 100 for event posting (S14).

The DataConsumer in the application 100 calls up a receive function for generating remote service in order to post the event to the CM 200, which is an event master (S15). By remote service, an event is posted to the DataRedirection 230 of the CM 200 so as to be processed in the CM 200 (S16).

Referring to FIG. 5B, the procedure (S20) for posting an event from the CM 200 to the relevant capsule X00 is described as follows. An event is posted to the DataQueue generated by the event processing function of the CM 200 (S21), and the DataQueue transmits the event entered into the assigned Queue to the eventThread (S22).

At the point, the process is overridden to the DataTransport class, and the Thread performs an infinite loop so as to receive another event (S23).

The CM 200 requests posting of an event object to the Relim 300 (S24), determining to which function a presently generated event should be posted (S25).

When the class that should be posted is determined, the validity as to whether an event object is used in the relevant capsule is determined through the filter 250 (S26), and a receive function for generating remote service is called up in order to post an event to the relevant capsule (S27). By means of remote service, an event-is posted to the DataRedirection X30 of the relevant capsule (S28).

Referring to FIG. 5C, the procedure (S30) for processing an event posted to the relevant capsule X00 is described as follows. The relevant event handling class is called up, depending on the kind of posted event, and the process is performed. If the posted event is an alarm event, an alarm event handling class is called up, and if the posted event is a fault event, a fault event handling class is called up.

As is apparent from the foregoing, if an interface of an interruption(an alarm/fault) event interface among many events is realized with the use of an event processing function according to the present invention, it is easy to realize on the user side, and an application user constructs data according to a predetermined event format, transmitting an event to a reliability module capsule by a single call using the event processing function included in its own capsule, so that a separate interface with the relim capsule is not necessary.

In addition, an alarm/fault element is easy to add/delete, and an alarm/fault event element defined in an .ini file is used, so that addition/deletion of an alarm/fault element is performed by modification of the .ini file only upon addition of an event. Of course, a data format change for an alarm/fault event is performed by change of the .ini file only.

While the invention has been shown and described with reference to certain preferred embodiments thereof, it will be understood by those skilled in the art that various changes in form and detail may be made therein without departing from the spirit and scope of the invention as defined by the appended claims.

Although preferred embodiments of the present invention have been described, it will be understood by those skilled in the art that the present invention should not be limited to the described preferred embodiments. Rather, various changes and modifications can be made within the spirit and scope of the present invention, as defined by the following claims.

What is claimed is:

1. A method for processing an event of a softswitch open type system, the method comprising the steps of:
(a) calling an event handler using an event processing function, and transmitting generated events to a configuration management (CM) element designated as an event processing master when an event is generated at each of a plurality of applications;
(b) posting each of the generated events to a relevant module according to a type of said each of the events; and
(c) processing by calling up a relevant event handling class in order to process said each of the generated events posted to the relevant module.

2. The method according to claim 1, wherein step (a) comprises the sub-steps of:
detecting an event generated at an application;
constructing an event at the event handler and calling up an issueEvent;
calling up an eventTransport in order to search a Thread;
requesting a DataTransport for event posting;
calling a remote service generating function at a DataConsumer in order to post the event to the CM element; and
posting the event to the DataConsumer of the CM by means of remote service.

3. The method according to claim 1, wherein step (b) comprises the sub-steps of:
posting an event to a DataQueue;
transmitting an event to an eventThread;
performing, at a Thread, an infinite loop in order to receive another event, wherein process is overridden to a DataTransport class;
requesting posting of an event object;
determining to which function an event should be posted;
determining validity as to whether the event object is used at a relevant capsule through a filter when a class to which the event should be posted is determined;
calling up a remote service generating function in order to post the event to the relevant capsule; and
posting the event to a DataConsumer of the relevant capsule using the remote service.

4. The method according to claim 3, wherein the step of posting the event to the DataQueue comprises the sub-steps of:
determining whether a relevant event RemoteConsumer is set to master;
requesting generation of an independent thread so that an event object of its own can be processed when the master is set to true;
generating, at a DataConsumer of a DataRedirection framework, which is a parent of the relevant event RemoteConsumer, an event posting DataQueue for the relevant event RemoteConsumer; and
performing a member process for processing an event when the event is posted to the DataQueue of the relevant event RemoteConsumer.

5. The method according to claim 3, wherein the step of determining validity as to whether the event object is used at a relevant capsule through a filter when the class to which the event would be posted is determined, comprises the sub-steps of:
requesting, at a relevant event RemoteConsumer, registration of the relevant event RemoteConsumer and a relevant event Filter on a DataTransport used by an event by using an event handler in a relevant event capsule in order to register the relevant event on the relevant event capsule with filtering of the relevant event;
using the remote service in order to register certain information as to the RemoteConsumer and the relevant event Filter on a master capsule of an event processing function;
sending the certain information to a DataRedirection framework of a master capsule, and registering the relevant event DataConsumer required by the relevant event capsule at the event processing function of the master capsule; and
registering the relevant event Filter for filtering a relevant event object.

6. A system for processing an event of a softswitch open type system, the system comprising:
first means for calling an event handler using an event processing function, and transmitting generated events to a configuration management (CM) element designated as an event processing master when an event is generated at each of a plurality of applications;
second means for posting each of the generated events to a relevant module according to a type of said each of the events; and
third means for processing by calling up a relevant event handling class in order to process said each of the generated events posted to the relevant module.

7. The system according to claim 6, wherein said first means:
detects an event generated at an application;
constructs an event at the event handler and calls up an issueEvent;
calls up an eventTransport in order to search a Thread;
requests a DataTransport for event posting;
calls a remote service generating function at a DataConsumer in order to post the event to the CM element; and
posts the event to the DataConsumer of the CM by means of remote service.

8. The system according to claim 6, wherein said second means:
posts an event to a DataQueue;
transmits an event to an eventThread;
performs, at a Thread, an infinite loop in order to receive another event, wherein process is overridden to a DataTransport class;
requests posting of an event object;
determines to which function an event should be posted;
determines validity as to whether the event object is used at a relevant capsule through a filter when a class to which the event should be posted is determined;
calls up a remote service generating function in order to post the event to the relevant capsule; and
posts the event to a DataConsumer of the relevant capsule using the remote service.

9. The system according to claim 8, wherein the posting of the event to the DataQueue comprises:
determining whether a relevant event RemoteConsumer is set to master;
requesting generation of an independent thread so that an event object of its own can be processed when the master is set to true;
generating, at a DataConsumer of a DataRedirection framework, which is a parent of the relevant event RemoteConsumer, an event posting DataQueue for the relevant event RemoteConsumer; and
performing a member process for processing an event when the event is posted to the DataQueue of the relevant event RemoteConsumer.

10. The system according to claim 8, wherein the determining of validity as to whether the event object is used at a relevant capsule through a filter when the class to which the event would be posted is determined, comprises:
requesting, at a relevant event RemoteConsumer, registration of the relevant event RemoteConsumer and a relevant event Filter on a DataTransport used by an event by using an event handler in a relevant event capsule in order to register the relevant event on the relevant event capsule with filtering of the relevant event;
using the remote service in order to register certain information as to the RemoteConsumer and the relevant event Filter on a master capsule of an event processing function;
sending the certain information to a DataRedirection framework of a master capsule, and registering the relevant event DataConsumer required by the relevant event capsule at the event processing function of the master capsule; and
registering the relevant event Filter for filtering a relevant event object.
